(19) United States
(12) Patent Application Publication
(10) Pub. No.: US 2025/0381614 A1
(43) Pub. Date: Dec. 18, 2025

(54) LASER PULSE WIDTH SHORTENING FILM AND MANUFACTURING METHOD THEREOF

(71) Applicant: PUSAN NATIONAL UNIVERSITY INDUSTRY-UNIVERSITY COOPERATION FOUNDATION, Busan (KR)

(72) Inventors: Kwang Seuk KYHM, Busan (KR); Suck Won Hong, Busan (KR); Min Ju Kim, Busan (KR); Ro Woon Park, Busan (KR)

(73) Assignee: PUSAN NATIONAL UNIVERSITY INDUSTRY-UNIVERSITY COOPERATION FOUNDATION, Busan (KR)

(21) Appl. No.: 19/203,185

(22) Filed: May 9, 2025

(30) Foreign Application Priority Data
Jun. 12, 2024 (KR) 10-2024-0076062

(51) Int. Cl. B23K 26/0622; B23K 26/32

(52) U.S. Cl. CPC B23K 26/0624; B23K 26/32

(57) ABSTRACT

The manufacturing method of a laser pulse width shortening film according to the present invention includes: a filling step in which a graphene oxide colloid is filled into a container having an open upper surface; a covering step in which a guide film having a predetermined outer pattern perforated therein covers an opening of the container; a bonding step in which the graphene oxide colloid is filled into the inside of the outer pattern by the capillary principle; an agglomeration step in which a solvent of the graphene oxide colloid evaporates in the inside of the outer pattern to form a graphene film by agglomerating graphene oxide molecules; and a separation step in which at least the graphene film is separated from the guide film.

### CROSS REFERENCE TO RELATED APPLICATION

This application claims priority to Korean Patent Application No. 10-2024-0076062 (filed on Jun. 12, 2024), which is hereby incorporated by reference in its entirety.

### BACKGROUND

The present invention relates to a laser pulse width shortening film and a manufacturing method thereof for shortening the pulse width of a laser emitted from an optical device.

### DESCRIPTION OF THE RELATED ART

Lasers are widely used in various fields such as analysis, medicine, and others. In particular, as the scale of lasers becomes more reduced, such as femtoseconds, the usability of lasers for precision technology is further increasing

As an example of the above-described laser generating means, the preceding Korean Patent Publication No. 10-2013-0142886 discloses a laser apparatus and a femtosecond laser system including the same. In addition, the related art document discloses a solution for improving the beam alignment properties of the emitted laser.

Meanwhile, various compressors are being used to maintain or reduce the pulse width of the emitted laser. However, these conventional compressors have a relatively complex structure and are difficult to manufacture. Above all, the conventional compressors have a multilayer structure. This causes various interferences in the laser passing through a multilayer medium of the compressor, resulting in a problem in that it is difficult to substantially shorten the pulse width of the laser

### Related Art

Korean Patent Publication No. 10-2013-0142886

### SUMMARY

As a solution to the above-described problem, an object of the present invention is provide a laser pulse width shortening film that is easy to manufacture and capable of minimizing a laminated structure, and a manufacturing method thereof.

The manufacturing method of a laser pulse width shortening film according to the present invention includes: a filling step in which a graphene oxide colloid is filled into a container having an open upper surface; a covering step in which a guide film having a predetermined outer pattern perforated therein covers an opening of the container; a bonding step in which the graphene oxide colloid is filled into the inside of the outer pattern by the capillary principle; an agglomeration step in which a solvent of the graphene oxide colloid evaporates in the inside of the outer pattern to form a graphene film by agglomerating graphene oxide molecules; and a separation step in which at least the graphene film is separated from the guide film.

In addition, in the filling step, the water surface height of the graphene oxide colloid is higher than the height of the opening of the container.

In addition, in the filling step, the water surface of the graphene oxide colloid has a convex shape upward by the principle of surface tension.

In addition, the container has a hydrophobic surface.

In addition, the container includes silicon.

In addition, in the agglomeration step, an heating effect occurs at least on the outer pattern.

In addition, in the agglomeration step, the solvent evaporates while being transformed into a concave lens shape.

In addition, in the agglomeration step, the thickness of the graphene film varies in proportion to the concentration of the colloid.

In addition, a laser pulse width shortening film according to the present invention may be manufactured by the above-described manufacturing method.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings.

FIG. 1 shows a flowchart of a manufacturing method of a laser pulse width shortening film according to the present invention.

FIG. 2 shows a photograph of an embodiment of a laser pulse width shortening film according to the present invention.

FIG. 3 shows a schematic diagram illustrating an embodiment of a filling step shown in FIG. 1.

FIG. 4 shows a lateral schematic diagram illustrating an embodiment of a filling step shown in FIG. 3.

FIG. 5 shows a schematic diagram illustrating an embodiment of a covering step shown in FIG. 1.

FIG. 6 shows a planar schematic diagram illustrating a guide film shown in FIG. 5.

FIG. 7 shows a schematic diagram illustrating an embodiment of a bonding step shown in FIG. 1.

FIG. 8 shows a schematic diagram illustrating an embodiment of an agglomeration step shown in FIG. 1.

FIG. 9 shows a diagram illustrating the results of a computational fluid dynamics analysis test in the agglomeration step according to Example 3 of the present invention.

FIG. 10 shows an optical microscope photograph of a laser pulse width shortening film according to Example 3 of the present invention.

FIG. 11 shows a graph illustrating the X-ray photoelectron spectroscopy (XPS) analysis results of the laser pulse width shortening film according to Example 3 of the present invention.

FIG. 12 shows an electron microscope photograph of the laser pulse width shortening film according to Example 3 of the present invention.

FIG. 13 shows a graph illustrating the thickness of the laser pulse width shortening films according to Examples 1 to 4.

FIG. 14 shows a schematic diagram and a graph illustrating the pulse width shortening results of the laser pulse width shortening film according to Example 3 of the present invention.

### DETAILED DESCRIPTION

Prior to the detailed description of the present invention, specific details for implementing the present invention are included in the following examples and drawings. The same reference numerals refer to the same elements throughout the specification. Singular forms used herein include plural forms, unless the context clearly indicates otherwise.

Hereinafter, a laser pulse width shortening film and a manufacturing method thereof according to the present invention will be described with reference to the drawings.

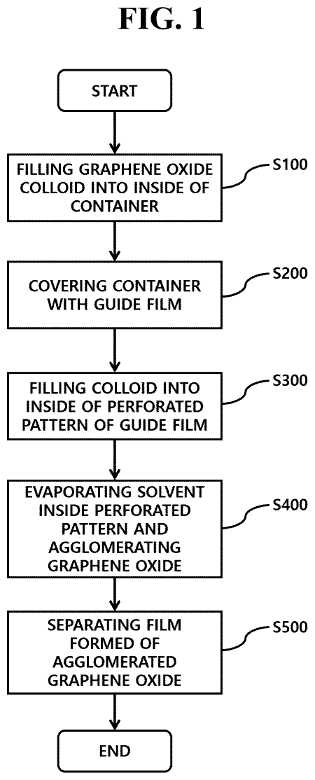

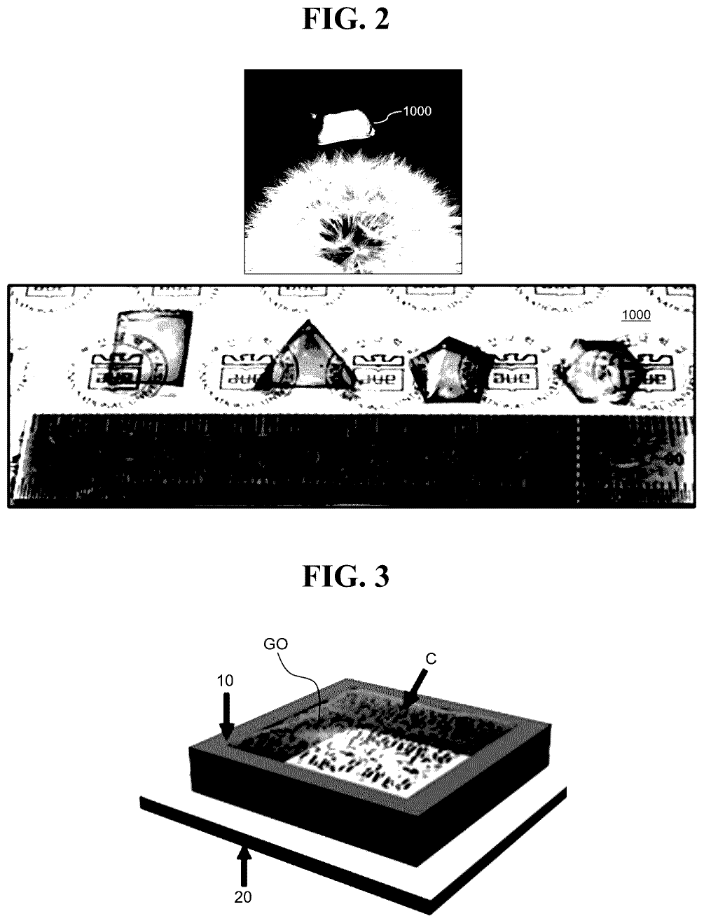

FIG. 1 shows a flowchart of a manufacturing method of a laser pulse width shortening film according to the present invention. In addition, FIG. 2 shows a photograph of an embodiment of a laser pulse width shortening film according to the present invention.

Referring to FIG. 1, the manufacturing method of the laser pulse width shortening film according to the present invention includes: a filling step S100, a covering step S200, a bonding step S300, an agglomeration step S400, and a separation step S500. In addition, particularly, referring to FIG. 2, the film 1000 according to the present invention is illustrated as being settled on a dandelion seed. In addition, the film 1000 may be freely manufactured with a smaller or larger area/thickness than this.

In addition, the film 1000 induces a saturation absorption (SA) phenomenon of light, thereby shortening the pulse time width of a laser passing through the film 1000. In addition, as an example of a material of the film 1000 that may easily induce the SA phenomenon of light, graphene oxide GO may be selected.

In addition, the film 1000 is formed into a single film structure. Accordingly, a medium interfering with the SA phenomenon of the graphene oxide GO is absent, so that the laser pulse width shortening function is smoothly implemented.

In addition, due to the above-described single film structure, the film 1000 may be free standing. Therefore, the installation convenience of the film 1000, such as installation into optical equipment, is ensured in various ways.

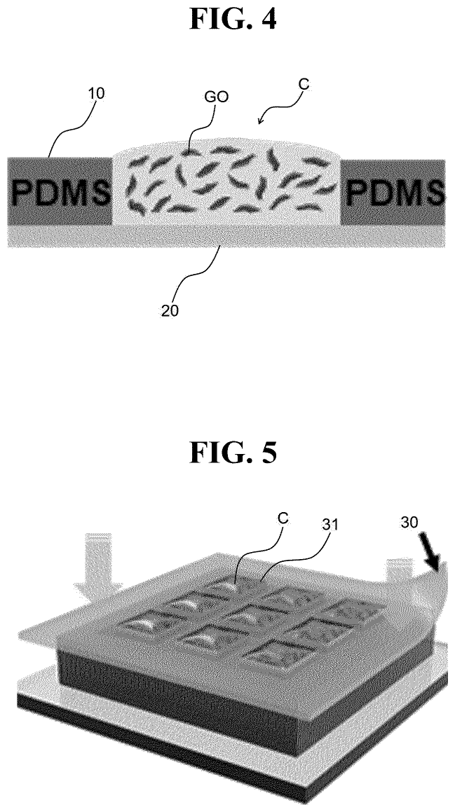

Next, FIG. 3 shows a schematic diagram illustrating an embodiment of a filling step shown in FIG. 1. In addition, FIG. 4 shows a lateral schematic diagram illustrating an embodiment of a filling step shown in FIG. 3.

Further referring to FIGS. 3 and 4, in the filling step S100, the colloid C of the above-described graphene oxide GO is prepared. In addition, the colloid C is filled into the inside of a container 10.

More specifically, the container 10 may have a shape with an open upper surface. In addition, a glass substrate 20 may be provided on the inner bottom surface of the container 10.

Here, in order to maximize the surface tension effect, the container 10 may be manufactured of a rubber-based material among hydrophobic polymers. For example, the container 10 may be manufactured of a material including silicon. More preferably, the container 10 may be manufactured of polydimethylsiloxane (PDMS).

In addition, according to the surface tension principle, the water surface of the colloid C may have a convex shape upward and may have a height higher than that of the opening of the container 10. For example, water may be used as a solvent for the colloid C. In addition, various materials capable of implementing the above-described surface tension principle may be used as a solvent for the colloid C.

In addition, a plurality of films 1000 may be simultaneously formed along the upper surface of the container 10. Therefore, the area of the upper surface of the container 10 may be determined in various ways to correspond to the number of films 1000 to be simultaneously produced.

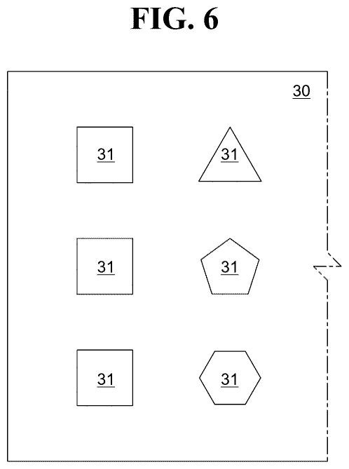

Next, FIG. 5 shows a schematic diagram illustrating an embodiment of a covering step shown in FIG. 1. In addition, FIG. 6 shows a planar schematic diagram illustrating a guide film shown in FIG. 5.

Further referring to FIGS. 5 and 6, in the covering step S200, the guide film 30 covers the opening of the container 10.

More specifically, the guide film 30 may have an area corresponding at least to the opening of the container 10. In addition, a plurality of outer patterns 31 may be perforated in the guide film 30. In addition, the film 1000 may be produced in a number corresponding to the number of outer patterns 31. In addition, referring to FIGS. 2 and 5 for comparison, the shape of the film 1000 may be determined corresponding to the shape of the outer pattern 31.

In addition, the guide film 30 may be manufactured of various polymer hydrophobic materials. For example, the guide film 30 may be manufactured of polyethylene terephthalate (PET).

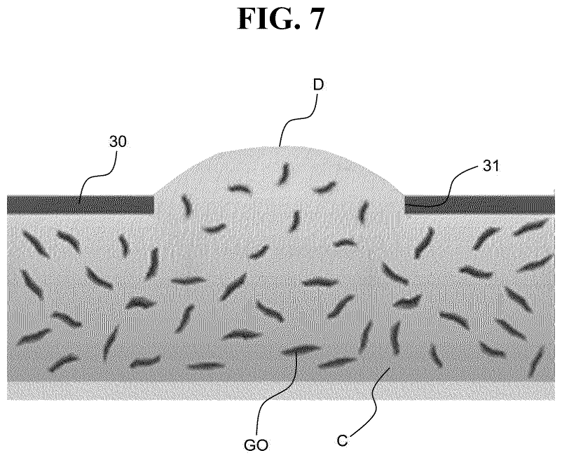

Next, FIG. 7 shows a schematic diagram illustrating an embodiment of a bonding step shown in FIG. 1.

Further referring to FIG. 7, in the above-described bonding step S300, the colloid C is filled into the inside of each outer pattern 31.

More specifically, through the filling step S100, the upper water surface of the colloid C protrudes upwards more than the container 10. The protruding portion of the colloid C comes into contact with the inside of the outer pattern 31. In addition, a type of capillary phenomenon occurs between the protruding portion of the colloid C and the outer pattern 31, so that the colloid C is filled into the inside of the outer pattern 31. In addition, by the principle of surface tension, the water surface of the colloid C has a convex shape upward and protrudes outward from the upper opening of the outer pattern 31.

In other words, by the principle of capillary or surface tension, the colloid C and the outer pattern 31 are temporarily bonded to each other.

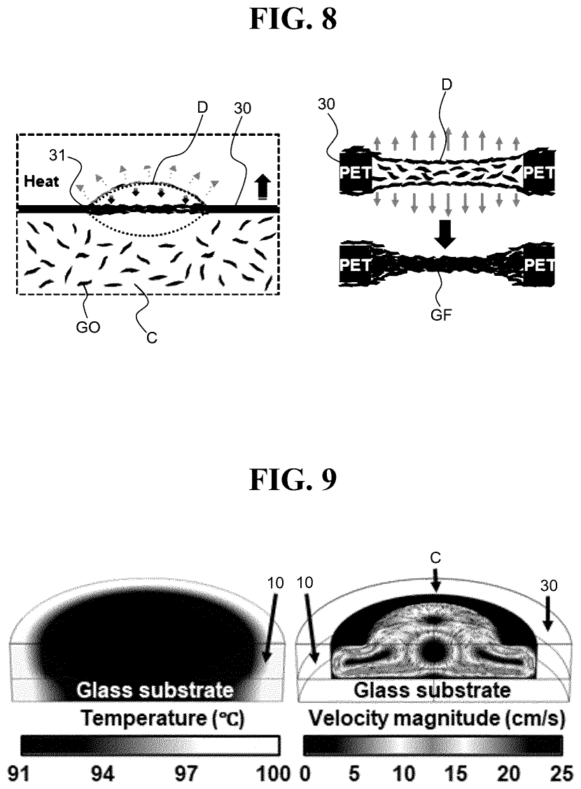

Next, FIG. 8 schematic diagram illustrating an embodiment of an agglomeration step shown in FIG. 1.

Further referring to FIG. 8, in the agglomeration step S400, the graphene oxide GO in the colloid C is agglomerated to form a graphene film GF.

More specifically, a heating effect may occur on the upper side of the outer pattern 31. More preferably, a uniform heating effect may occur on the entire outer surface of the container 10 and the guide film 30. Accordingly, an evaporation effect of the solvent occurs in the colloid C droplet D inside the outer pattern 31.

In addition, due to the evaporation effect of the colloid C solvent, the attractive force between the graphene oxide GO molecules, which are the solutes in the colloid C droplet D, is strengthened. Accordingly, the van der Waals force, such as hydrogen bonding, strongly acts between the graphene oxide GO molecules inside the colloid C droplet D, so that the graphene oxide GO molecules are self-assembled.

Furthermore, due to the evaporation action of the colloid C solvent, the meniscus of the colloid C droplet is transformed from a convex lens shape to a concave lens shape while being evaporated and shrunk.

In addition, as the agglomerated graphene oxide GO molecules are dried, a graphene film GF in the form of a sheet or film structure is finally formed.

Next, through the separation step S500, the graphene film GF is separated from the guide film 30, thereby forming a laser pulse width shortening film 1000. At this time, a laser, a cutter, and various other means may be selected to separate the film 1000.

In addition, since the guide film 30 outside the graphene film GF is cut, the film 1000 may include the guide film 30. Alternatively, the film 1000 may be formed without a separate guide film 30 cutting process. In other words, the guide film 30 and the graphene film GF may be integrally formed into the film 1000. The guide film 30 integrally provided on the outside the graphene film GF may be utilized as a bonding means or a protective means for installing the film 1000 in an optical device, and the like.

Alternatively, the film 1000 may be formed by cutting the inner side of the graphene film GF.

### Example 1

The film 1000 according to Example 1 of the present invention was manufactured through the above-described manufacturing method.

More specifically, first, for the filling step S100, a PDMS-based container 10 was manufactured. In addition, a glass substrate 20 was provided on the bottom surface of the container 10. In addition, a graphene oxide GO colloid C at a concentration of 2 mg/ml based on a water solvent was provided.

Next, for the covering step S200, a guide film 30 was provided based on a PET film having a thickness of 25 μm. At this time, the colloid C droplet D inside the outer pattern 31 had a contact angle of 70° with respect to the water surface.

Next, for the agglomeration step S400, the above-described equipment and materials were accommodated inside a high-temperature chamber. Thereafter, a heating operation of the chamber was performed under the conditions of atmospheric pressure and 100° C.

Next, the separation step S500 was performed by separating the graphene film GF generated by the agglomeration step S400.

### Example 2

For the manufacture of the film 1000 according to this example, a graphene oxide GO colloid C at a concentration of 1.5 mg/ml was prepared. Other manufacturing conditions were the same as in Example 1.

### Example 3

For the manufacture of the film 1000 according to this example, a graphene oxide GO colloid C at a concentration of 1 mg/ml was prepared. Other manufacturing conditions were the same as in Example 1.

### Example 4

For the manufacture of the film 1000 according to this example, a graphene oxide GO colloid C at a concentration of 0.5 mg/ml was prepared. Other manufacturing conditions were the same as in Example 1.

### Test Example 1

FIG. 9 shows a diagram illustrating the results of a computational fluid dynamics analysis test in the agglomeration step according to Example 3 of the present invention. Further referring to FIG. 9, a computational fluid dynamics analysis test was performed on the agglomeration step S400 of the manufacturing method according to Example 3. Here, the left side of FIG. 9 shows the temperature distribution of the test subject. In addition, the right side of FIG. 9 shows the flow velocity of the particles.

As a result of the test, it was confirmed that the graphene oxide GO molecules floating/immersed in the colloid C solution were smoothly agglomerated in the central long axis direction of the PET guide film 30.

In particular, referring FIGS. 8 and 9 together, the flow velocity change behavior of the particles corresponding to the formation of the concave droplet D was confirmed. In this regard, the analysis identified that heat transfer occurring during the heating process, convective flow change due to surface tension change, air buoyancy change, and the like, are the main factors of thermal capillary-related actions.

In addition, it was confirmed that the graphene oxide GO molecules were e smoothly agglomerated by the above-described thermal capillary action into a concave shape along the tangent line of the liquid-air interface.

In addition, the same test results were confirmed for other examples.

### Test Example 2

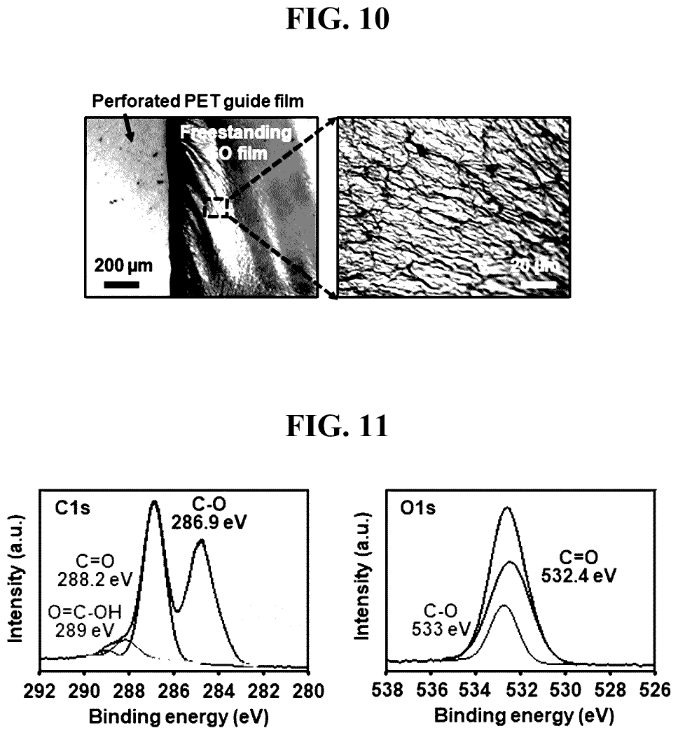

FIG. 10 shows an optical microscope photograph of a laser pulse width shortening film according to Example 3 of the present invention. Further referring to FIG. 10, an optical microscopic image of the film 1000 manufactured according to Example 3 was taken.

As a result of the imaging, a continuous plate-like structure unique to the graphene film was clearly confirmed. As such, the agglomeration/self-assembly simulation results of graphene oxide GO molecules, confirmed in Test Example 1, were actually smoothly implemented, confirming that mass production of high-quality products is possible.

In addition, the same test results were confirmed for other examples.

### Test Example 3

FIG. 11 shows a graph illustrating the X-ray photoelectron spectroscopy (XPS) analysis results of the laser pulse width shortening film according to Example 3 of the present invention.

Further referring to FIG. 11, the XPS analysis results confirmed various peak values that specify graphene oxide, such as various carbon-carbon and carbon-oxygen single/double bonds. Therefore, it was confirmed that the film 1000 manufactured by Example 3 was structurally intact.

In addition, the same test results were confirmed for other examples.

### Test Example 4

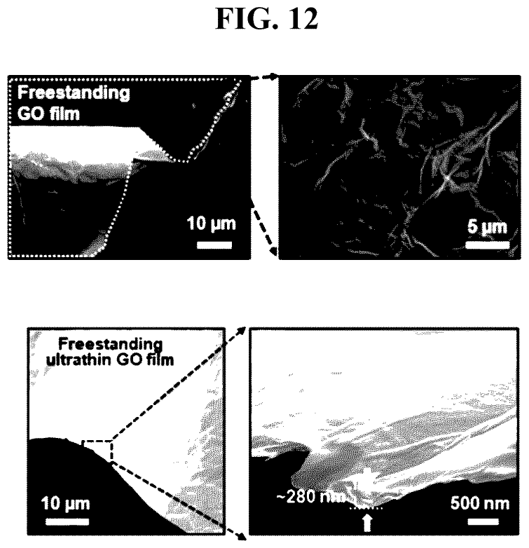

FIG. 12 shows an electron microscope photograph of the laser pulse width shortening film according to Example 3 of the present invention.

Further referring to FIG. 12, it was confirmed that the film 1000 according to Example 3 had good quality without any cut portions. In particular, it was confirmed that the film 1000 has excellent physical properties despite having an ultra-fine thickness of about 280 nm.

### Test Example 5

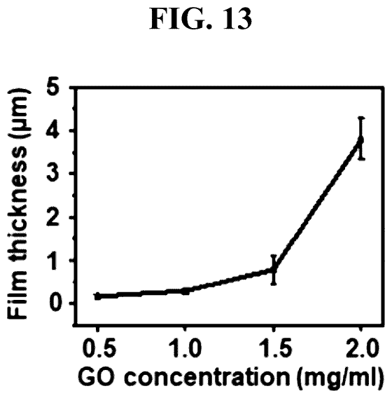

FIG. 13 shows a graph illustrating the thickness of the laser pulse width shortening films according to Examples 1 to 4.

Further referring to FIG. 13, the thickness of the film 1000 of each example was measured through electron microscopy. As a result of the test, it was confirmed that the concentration of the colloid C and the thickness of the finally manufactured film 1000 were mutually proportional.

In particular, it was confirmed that the film 1000 with a nano-scale thickness could be manufactured at a colloid C concentration of 1.5 mg/ml or less.

In addition, a trend of rapid thickness increase of the film 1000 was confirmed in the colloid C concentration range exceeding 1.5 mg/ml. Through this, it was confirmed that the thickness of the film 1000 could be sufficiently thickened as needed within the micro-scale range. In addition, it was confirmed that the film 1000 with various thicknesses could be manufactured by attempting various adjustments to the concentration of the collide C.

In particular, it was confirmed that even when the colloid C concentration increased or decreased, only the thickness of the finally manufactured film 1000 was changed, and the density of the graphene oxide GO within the film 1000 remained constant. In this respect, it was analyzed that there is almost no deterioration in the product quality due to the changes in the thickness of the film 1000.

### Test Example 6

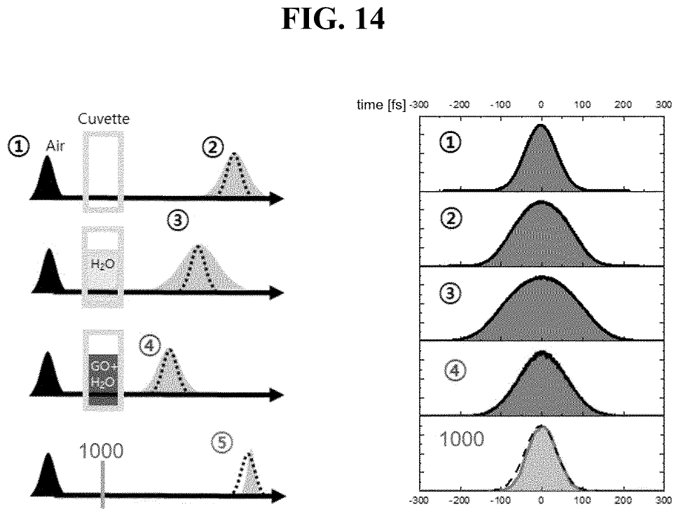

FIG. 14 shows a schematic diagram and a graph illustrating the pulse width shortening results of the laser pulse width shortening film according to Example 3 of the present invention.

Further referring to FIG. 14, the pulse width of the femtosecond laser passing through each of the air (1), an empty cuvette container (2), a cuvette container filled with water (3), a cuvette container filled with graphene oxide colloid (4), and the film 1000 according to Example 3 was measured. At this time, the test results for the air (1) may be understood as being close to the initial value of the femtosecond laser.

As a result of the test, it was confirmed that when the laser passed through the film 1000 of the present invention, the pulse width of the laser was shortened. However, it was confirmed that when the laser passed through other media, the pulse width of the laser increased compared to the initial value. In addition, the same test results were confirmed for other examples.

Meanwhile, in the case of the cuvette container (4) filled with the graphene oxide colloid, a shorter pulse width was found compared to the cuvette container (3) filled with water. However, in the case of the cuvette container (4) filled with the graphene oxide colloid, a much greater pulse width was found compared to the film 1000. In this respect, it can be seen that even when the graphene oxide GO is utilized, the pulse width of the laser increases compared to the initial value as long as the laser passes through a different medium.

As shown in the above-described test results, it was confirmed that the manufacturing method of the film 1000 according to the present invention is suitable for the mass production of a structurally stable and intact graphene oxide film 1000. In addition, it was confirmed that the laser pulse width shortening effect of the film 1000 manufactured by the present invention was obviously performed effectively.

According to the present invention, a laser passes only through a graphene oxide-based single-layer film. In other words, since no medium interfering with the optical properties of the laser is added, a laser pulse width shortening effect can be consistently implemented therethrough.

In addition, the film can be mass-produced through a solution-based process. Therefore, even without the addition of complex and costly mechanical/optical/circuitry designs, high-performance laser pulse width shortening means can be easily manufactured at a low cost.

In addition, various manufacturing advantages are provided, such as the thickness of the film can be freely varied while being uniform just by controlling the colloid concentration in the solution-based process.

In addition, various manufacturing advantages are provided, such as the shape of the film can be freely varied just by changing the shape of the pattern perforated in the guide film in the solution-based process.

As described above, the main technical idea of the present invention is to provide a laser pulse width shortening method thereof. In addition, the film and a manufacturing embodiments described above with reference to the drawings are only some embodiments, and the scope of the rights of the present invention should be determined based on the scope of the patent claims. In addition, the scope of the rights of the present invention also extends to various equivalent embodiments that can be derived.

### REFERENCE NUMERALS

10: container
20: glass substrate
30: guide film
31: outer pattern
1000: laser pulse width shortening film according to the present invention
GF: graphene film

1. A manufacturing method of a laser pulse width shortening film, the method comprising:
a filling step in which a graphene oxide colloid is filled into a container having an open upper surface;
a covering step in which a guide film having a predetermined outer pattern perforated therein covers an opening of the container;
a bonding step in which the graphene oxide colloid is filled into the inside of the outer pattern by the capillary principle;
an agglomeration step in which a solvent of the graphene oxide colloid evaporates in the inside of the outer pattern to form a graphene film by agglomerating graphene oxide molecules; and
a separation step in which at least the graphene film is separated from the guide film.

2. The manufacturing method of the laser pulse width shortening film according to claim 1, wherein in the filling step, the water surface height of the graphene oxide colloid is higher than the height of the opening of the container.

3. The manufacturing method of the laser pulse width shortening film according to claim 2, wherein in the filling step, the water surface of the graphene oxide colloid has a convex shape upward by the principle of surface tension.

4. The manufacturing method of the laser pulse width shortening film according to claim 3, wherein the container has a hydrophobic surface.

5. The manufacturing method of the laser pulse width shortening film according to claim 4, wherein the container includes silicon.

6. The manufacturing method of the laser pulse width shortening film according to claim 3, wherein in the agglomeration step, an heating effect occurs at least on the outer pattern.

7. The manufacturing method of the laser pulse width shortening film according to claim 6, wherein in the agglomeration step, the solvent evaporates while being transformed into a concave lens shape.

8. The manufacturing method of the laser pulse width shortening film according to claim 6, wherein in the agglomeration step, the thickness of the graphene film varies in proportion to the concentration of the colloid.

9. A laser pulse width shortening film manufactured by the manufacturing method according to claim 1.
